(19) United States
(12) Patent Application Publication
(10) Pub. No.: US 2021/0027109 A1
(43) Pub. Date: Jan. 28, 2021

(54) EVALUATION SYSTEM, EVALUATION METHOD, AND PROGRAM FOR EVALUATION

(71) Applicant: NEC Corporation, Minato-ku, Tokyo (JP)

(72) Inventors: Shinji ITO, Tokyo (JP); Ryohei FUJIMAKI, Tokyo (JP)

(73) Assignee: NEC Corporation, Minato-ku, Tokyo (JP)

(21) Appl. No.: 17/043,329

(22) PCT Filed: Oct. 29, 2018
(86) PCT No.: PCT/JP2018/040117

§ 371 Date: Sep. 29, 2020

Related U.S. Application Data
(60) Provisional application No. 62/650,389, filed on Mar. 30, 2018.

(51) Int. Cl. G06K 9/62; G06N 20/00

(52) U.S. Cl. CPC G06K 9/6262; G06N 7/005; G06N 20/00

(57) ABSTRACT

A learning unit 81 generates a plurality of sample groups from samples used for learning, each of the sample groups containing at least one of samples not contained in the other sample groups, and generates a plurality of prediction models using each of the generated sample groups. An optimization unit 82 generates objective functions, represented by the sum of a plurality of functions, on the basis of explained variables predicted by the prediction models and constraints for optimization, and optimizes the generated objective functions. An evaluation unit 83 evaluates a result of the optimization for each of the objective functions.

### TECHNICAL FIELD

The present invention relates to an evaluation system, an evaluation method, and a program for evaluation, for evaluating the result of prediction-based optimization.

### BACKGROUND ART

In recent years, data-driven decision making has attracted considerable attention and has been used in many practical applications. One of the most promising approaches is mathematical optimization based on a prediction model generated by machine learning. Recent advances in machine learning have made it easier to create an accurate prediction model, and predicted results have been used to construct a mathematical optimization problem. In the following, such a problem will be referred to as predictive mathematical optimization or simply as predictive optimization.

These approaches are used in applications such as water distribution optimization, energy generation planning, retail price optimization, supply chain management, and portfolio optimization, where frequent trial-and-error processes cannot be said to be practical.

One important feature of predictive optimization is that, unlike standard optimization, an objective function is estimated by machine learning. For example, in price optimization based on predictions, future returns are inherently unknown, so the function for predicting returns is estimated as a function of product price by a demand regression equation.

Patent Literature (PTL) 1 describes an order plan determination device that determines a product order plan. The order plan determination device described in PTL 1 predicts demands of the product at each price, and uses the predicted demands to solve a problem of optimizing an objective function having a price and an order quantity as inputs and a profit as an output, to thereby calculate a combination of the price and the order quantity of the product that yields a maximum profit.

Non Patent Literature (NPL) 1 describes a method of determining an appropriate discount for a given Sharpe ratio.

### CITATION LIST

### Patent Literature

PTL 1: Japanese Patent Application Laid-Open No. 2016-110591

### Non Patent Literature

NPL 1: Harvey, Campbell R and Liu, Yan, “Backtesting”, SSRN Electronic Journal, 2015

### SUMMARY OF INVENTION

### Technical Problem

One specific way to determine a strategy on the basis of prediction is to create a prediction model on the basis of observed data and calculate an optimal strategy on the basis of the prediction model, as described in PTL 1. At this time, it is important to estimate the effects of the optimized results. One simple way to evaluate the effects is to estimate the effects of an optimal solution using the prediction model used for the optimization. However, PTL 1 describes no specific way of estimating the effects.

Now assume an estimated objective function f(z, θ\hat{ }) with respect to a (true) objective function f(z, θ*) representing the reality itself. It should be noted that in the present description, the superscript \hat{ } may be placed next to a symbol. For example, θ with the superscript \hat{ } may be written as θ\hat{ }.

Here, z and θ represent a decision variable and a parameter of f, respectively. Further, an estimated optimal strategy is represented as z\hat{ }. That is, the following holds:

\hat{z}=arg ma [symbol] f(z,\hat{θ}) [Math. 1]

where Z represents a range within which z can move.

In predictive optimization, actual effects of the estimated optimal strategy correspond to f(z\hat{ }, θ*), so it is important to estimate this value. On the other hand, it is difficult to observe f(z\hat{ }, θ*) because it requires executing the strategy z\hat{ } in real environments. For this reason, f(z\hat{ }, θ*) is generally estimated by f(z\hat{ }, θ\hat{ }) for evaluating the effects of z\hat{ }.

However, as described in NPL 1, f(z\hat{ }, θ\hat{ }) tends to become very optimistic in algorithmic investment or portfolio optimization. In other words, the optimal value based on the estimation is generally biased towards optimism.

According to the description in NPL 1, a common method for evaluating trading strategies is a simple heuristic method of discounting the estimated target by 50%. That is, in NPL 1, 0.5 f(z\hat{ }, θ\hat{ }) is regarded as an estimator of f(z, θ*). Recent studies have also proposed statistically analyzed, problem mitigating algorithms.

However, these algorithms are limited to specific applications (e.g., algorithmic investment). Furthermore, in ordinary predictive optimization problems, there are no validated algorithms for a bias-free estimator of f(z, θ*).

In view of the foregoing, it is an object of the present invention to provide an evaluation system, an evaluation method, and a program for evaluation that can perform an evaluation while suppressing an optimistic bias in predictive optimization.

### Solution to Problem

An evaluation system according to the present invention includes: a learning unit configured to generate a plurality of sample groups from samples used for learning, each of the sample groups containing at least one of samples not contained in the other sample groups, and generate a plurality of prediction models using each of the generated sample groups; an optimization unit configured to generate objective functions, represented by the sum of a plurality of functions, on the basis of explained variables predicted by the prediction models and constraints for optimization, and optimize the generated objective functions; and an evaluation unit configured to evaluate a result of the optimization for each of the objective functions.

An evaluation method according to the present invention includes: generating a plurality of sample groups from samples used for learning, each of the sample groups containing at least one of samples not contained in the other sample groups; generating a plurality of prediction models using each of the generated sample groups; generating objective functions, represented by the sum of a plurality of functions, on the basis of explained variables predicted by the prediction models and constraints for optimization; optimizing the generated objective functions; and evaluating a result of the optimization for each of the objective functions.

A program for evaluation according to the present invention causes a computer to perform: learning processing of generating a plurality of sample groups from samples used for learning, each of the sample groups containing at least one of samples not contained in the other sample groups, and generating a plurality of prediction models using each of the generated sample groups; optimization processing of generating objective functions, represented by the sum of a plurality of functions, on the basis of explained variables predicted by the prediction models and constraints for optimization, and optimizing the generated objective functions; and evaluation processing of evaluating a result of the optimization for each of the objective functions.

### Advantageous Effects of Invention

According to the present invention, it is possible to perform an evaluation, while suppressing an optimistic bias in predictive optimization.

### BRIEF DESCRIPTION OF DRAWINGS

FIG. 1 is a block diagram showing an exemplary configuration of an embodiment of an evaluation system according to the present invention.

FIG. 2 is a diagram illustrating an example of learning data.

FIG. 3 is a diagram illustrating an example of external factor data.

FIG. 4 is a diagram illustrating an example of constraints.

FIG. 5 is a diagram illustrating an example of a prediction model.

FIG. 6 is a diagram illustrating examples of optimization problems.

FIG. 7 is a diagram illustrating examples of outputting evaluation results.

FIG. 8 is a diagram illustrating an example of outputting evaluation results.

FIG. 9 is a flowchart illustrating an exemplary operation of the evaluation system.

FIG. 10 is a flowchart illustrating an example of an evaluation method using a cross validation method.

FIG. 11 is a flowchart illustrating an example of an evaluation method using a bootstrap method.

FIG. 12 is a block diagram showing an overview of the evaluation system according to the present invention.

FIG. 13 is a schematic block diagram showing a configuration of a computer according to at least one embodiment.

### DESCRIPTION OF EMBODIMENT

Firstly, an optimistic bias in an optimal value will be described using a specific example. Here, in order to simplify the explanation, the case of estimating an expected value of profit in a coin toss game will be described. In the coin toss game described here, a player predicts whether a tossed coin will land heads up (H) or tails up (T). It is assumed that the player will get one dollar when the player's prediction comes true; otherwise, the player will get nothing.

Here, when three attempts are made, there are four patterns of results: (1) heads for all three times (HHH), (2) heads for twice and tails for once (HHT), (3) heads for once and tails for twice (HTT), and (4) tails for all three times (TTT). In these four patterns, the probabilities of heads are estimated to be 1 in (1), ⅔ in (2), ⅓ in (3), and 0 in (4).

Taking account of the probabilities of heads in the respective patterns, it is considered to be optimal to bet on heads in the patterns (1) and (2) and bet on tails in the patterns (3) and (4). When the player bets in this manner, the expected profit in the pattern (1) will be 1×1 dollar=$1; the expected profit in the pattern (2) will be ⅔×1 dollar=$0.67; the expected profit in the pattern (3) will be (1−⅓)×1 dollar=$0.67; and the expected profit in the pattern (4) will be (1−0)×1 dollar=$1. When the probability of heads is ½, the probabilities that the patterns (1), (2), (3), and (4) are observed will be ⅛, ⅜, ⅜, and ⅛, respectively. Accordingly, the expected value of profit in consideration of the optimal solutions to these four patterns is calculated to be 1×⅛+0.67×⅜+0.67×⅜+1×⅛=$0.75. This is the expected value of the profit estimate when selecting optimal solutions on the basis of predictions.

However, the probability of heads (or tails) when tossing a coin is ½. So, the expected profit should be ½×1 dollar=$0.5. This demonstrates that the expected value ($0.75) of the profit estimate when selecting optimal solutions on the basis of predictions includes an optimistic bias in comparison with the actual expected profit ($0.5).

A description will now be made about the reasons why f(z\hat{ }, θ\hat{ }) cannot be said to be an appropriate estimator of f(z\hat{ }, θ*) even if θ\hat{ } is an appropriate estimator of θ*.

Suppose that an objective function f(z, θ\hat{ }) is an unbiased estimator of a true objective function f(z, θ*), or, that the following expression 1 holds.

[Math. 2]

[symbol]

ₓ[f(z,\hat{θ})]= [symbol] ₓ[f(z,θ*)], z∈ [symbol] (Expression 1)

The equal sign in the above expression 1 suggests that Ex[f(z\hat{ }, θ\hat{ })] and f(z\hat{ }, θ\hat{ }) may be estimators of Ex[f(z\hat{ }, θ*)] and f(z\hat{ }, θ*), respectively. However, there exists the following theorem.

That is, suppose that the expression 1 is satisfied and that z\hat{ } and z* satisfy the following conditions, respectively.

\hat{z}∈arg ma [symbol] f(z,\hat{θ})

z*∈arg ma [symbol] f(z,θ*) [Math. 3]

In this case, the expression 2 below holds. Further, if it is probable that z\hat{ } is not optimal for the true objective function f(z, θ*), then the inequation on the right in the expression 2 holds with the inequality sign.

[Math. 4]

[symbol]

ₓ[f(\hat{z},\hat{θ})]≥f(z*,θ*)≥ [symbol] ₓ[f(\hat{z},θ*)] (Expression 2)

This theorem means that even if the estimated objective function f(z, θ\hat{ }) is an unbiased estimator of the true objective function, the estimated optimal value f(z\hat{ }, θ\hat{ }) is not an unbiased estimator of f(z\hat{ }, θ*).

The optimistic bias is known empirically in the context of portfolio optimization. While bias correction methods based on statistical testing have been proposed for this problem, they are applicable only when the objective function is a Sharpe ratio. While these methods are applicable to general predictive optimization problems, they have made no mention about obtaining a bias-free estimator.

To address this problem, the present inventors have found a solution based on cross validation with empirical risk minimization (ERM). Specifically, the present inventors have discovered a method of solving the problem of optimistic bias by using a solution to overfitting in machine learning.

In supervised machine learning, a learner determines a prediction rule h\hat{ }∈H by minimizing an empirical risk. That is, the expression 3 below holds.

$$\begin{matrix}[ Math . 5 ] & \\ \hat{h} ∈ arg {min}_{h ∈ ℋ} \frac{1}{n} {\sum }_{n = 1}^{N} 𝓁 ( h , {x}_{n} ) & ( Expression 3 )\end{matrix}$$

In the expression 3, xₙ represents observed data generated from a distribution D, and 1 represents a loss function. The empirical risk shown in the following expression 4:

$$\begin{matrix}[ Math . 6 ] & \\ \frac{1}{N} {\sum }_{n = 1}^{N} 𝓁 ( h , {x}_{n} ) & ( Expression 4 )\end{matrix}$$

is a bias-free estimator of a generalization error

[symbol]

(h):= [symbol] [ [symbol] (h,x)] [Math. 7]

in an arbitrary, fixed prediction rule h. That is, the following expression 5 holds for the arbitrary, fixed h.

$$\begin{matrix}[ Math . 8 ] & \\ {𝔼}_{{x}_{n} ∼ 𝒟} [ \frac{1}{N} {\sum }_{n = 1}^{N} 𝓁 ( h , {x}_{n} ) ] = {𝓁}_{𝒟} ( h ) & ( Expression 5 )\end{matrix}$$

Despite the expression 5 above, in most cases, the empirical risk of the calculated parameter h\hat{ } is smaller than the generalization error of h\hat{ }. This is because, as is well known, h\hat{ } overfits to the observed samples.

In response to such a situation, the inventors have found that the problems of optimistic bias and overfitting in machine learning are caused by the reuse of the data set in the evaluation of objective function and the evaluation of objective value.

Table 1 shows a comparison between empirical risk minimization (ERM) and predictive optimization.

TABLE 1
Comparison between Empirical Risk
Minimization and Predictive Optimization

| | Empirical Risk Minimization | Optimization |
|---|---|---|
| Decision Variable | Prediction h | Strategy z |
| True Objective | [symbol] [l(h, x)] | f(z, θ*) |
| Function | | |
| Estimated Objective Function | $\frac{1}{N} {\sum }_{n = 1}^{N} l ( h , {x}_{n} )$ | f(z, \hat{θ}) |

As shown in Table 1, the problem of bias in predictive optimization has a structure similar to that of the problem of minimizing the empirical risk. Typical methods for estimating generalization errors in machine learning are cross validation and asymptotic bias correction, such as the Akaike Information Criterion (AIC).

In consideration of the above, in the present embodiment, a bias-free estimator is generated for the value f(z\hat{ }, θ*) of the true objective function in the calculated strategy. That is, in the present embodiment, an estimator ρ(Xⁿ→R) that satisfies the following expression 6 is generated. In the present embodiment, a bias-free estimator of θ* is assumed to be θ\hat{ }.

[Math. 9]

[symbol]

ₓ[ρ(x)]= [symbol] ₓ[f(\hat{z},θ*)] (Expression 6)

The present inventors have also found that similar problems as described above exist when an objective function can be represented by the sum of a plurality of functions. That is, simply estimating the values of respective functions included in the objective function will result in overestimation (i.e., optimistic evaluation) of the individual results. Accordingly, in the present invention, a description will be given about a method, when an objective function can be represented by the sum of a plurality of functions, of evaluating the result of optimization for each of those functions. That is, it is assumed in the following description that an objective function f(z, θ*) can be represented by a plurality of functions as in the expression 7 illustrated below, and that values of f₁(z\hat{ }, θ*), . . . , fₘ(z′, θ*) will be estimated for an optimal solution z\hat{ } obtained.

[Math. 10]

f(z,θ*)=f₁(z,θ*)+ . . . +fₘ(z,θ*) (Expression 7)

On the basis of the foregoing assumptions, embodiments of the present invention will be described below with reference to the drawings. In the following, price optimization based on predictions will be described by giving specific examples. In the example of price optimization based on predictions, a predicted profit corresponds to the evaluation result. Generally, in price optimization that maximizes gross profits, the objective function is expressed as the sum of sales profits of a plurality of products. The use of the method shown in the present embodiment enables estimation of profits obtained from the respective products, while suppressing an optimistic bias.

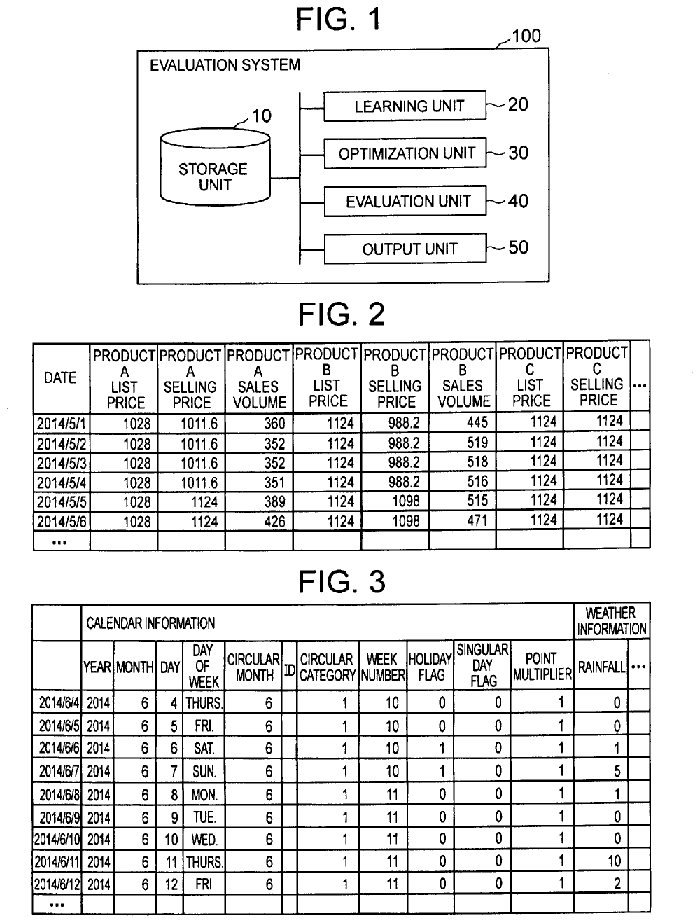

FIG. 1 is a block diagram showing an exemplary configuration of an embodiment of an evaluation system according to the present invention. The evaluation system 100 of the present embodiment includes a storage unit 10, a learning unit 20, an optimization unit 30, an evaluation unit 40, and an output unit 50.

The storage unit 10 stores learning data (hereinafter, also referred to as samples) used for learning by the learning unit 20, which will be described later. In the case of price optimization, data representing historical sales data and prices, and factors affecting sales (hereinafter, also referred to as external factor data) are stored as the learning data.

FIG. 2 is a diagram illustrating an example of learning data. The learning data illustrated in FIG. 2 shows an example in which the list price of each product, the selling price actually set for the product, and the sales volume of each product are stored by date.

FIG. 3 is a diagram illustrating an example of external factor data. The external factor data illustrated in FIG. 3 shows an example in which calendar information is stored by date. Further, as illustrated in FIG. 3, the external factor data may include weather forecast or other data.

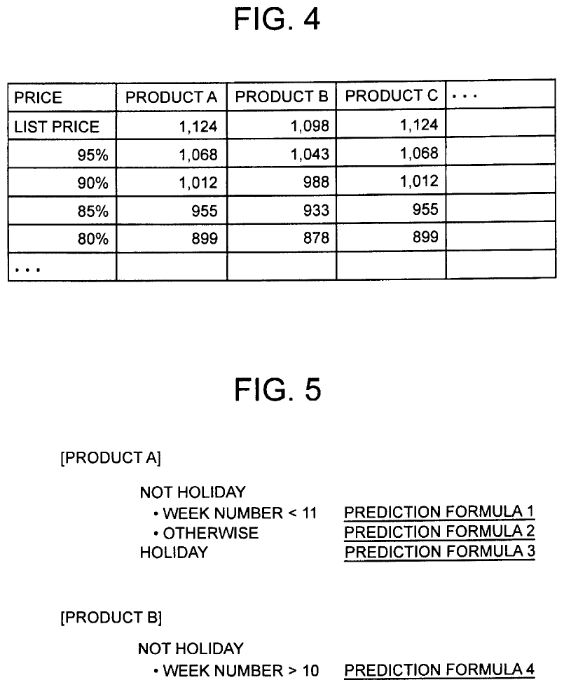

The storage unit 10 further stores constraints used when the optimization unit 30, which will be described later, performs optimization processing. FIG. 4 is a diagram illustrating an example of constraints. The constraints illustrated in FIG. 4 indicate that a possible selling price is determined in accordance with the discount rate for each product's list price. The storage unit 10 is implemented by, for example, a magnetic disk or the like.

The learning unit 20 generates a prediction model that predicts a variable used for optimization calculation. For example, in the case of a problem of optimizing the prices to maximize gross sales, the learning unit 20 may generate a prediction model to predict the sales volumes, because sales are calculated by the product of price and sales volume. In the following description, an explanatory variable means a variable that can affect a prediction target. For example, in the case where the prediction target is the sales volume, the selling price and sales volume of the product in the past, calendar information, etc. are the explanatory variables.

In the field of machine learning, the prediction target is also called an “objective variable”. In the following description, in order to avoid confusion with the “objective variable” generally used in optimization processing which will be described later, the variable representing the prediction target will be referred to as an explained variable. The prediction model can thus be said to be a model that expresses an explained variable using one or more explanatory variables.

Specifically, the learning unit 20 generates a plurality of sample groups from samples used for learning in such a manner that the samples contained in the respective groups are at least partially different from each other, and generates a plurality of prediction models using respective ones of the generated sample groups. In the following, to simplify the explanation, the case of generating, from samples used for learning, two sample groups (hereinafter, referred to as first sample group and second sample group) containing the samples at least partially different from each other will be described. It should be noted that the number of sample groups generated is not limited to two; three or more groups may be generated.

Specifically, in the case where the evaluation unit 40, which will be described later, performs an evaluation using cross validation, the learning unit 20 generates a plurality of sample groups from the group of samples used for learning, and generates a plurality of prediction models such that the sample groups among the generated sample groups used for learning of the respective models will not overlap each other. For example, in the case where two sample groups are generated, the learning unit 20 uses the first sample group to generate a first prediction model predicting the sales volumes of products, and uses the second sample group to generate a second prediction model predicting the sales volumes of products.

Further, in the case where the evaluation unit 40, described later, performs an evaluation using a bootstrap method, the learning unit 20 generates a plurality of sample groups by sampling with replacement from the group of samples used for learning, and generates a plurality of prediction models using respective ones of the generated sample groups.

The way for the learning unit 20 to generate a prediction model is not limited. The learning unit 20 may generate a prediction model using a machine learning engine such as factorized asymptotic Bayesian inference (FAB). FIG. 5 is a diagram illustrating an example of a prediction model. The prediction model illustrated in FIG. 5 is a prediction model that predicts the sales volume of each product, in which a prediction formula is selected in accordance with the contents of explanatory variables.

The optimization unit 30 generates an objective function on the basis of an explained variable predicted by the generated prediction model and constraints for optimization. Specifically, the optimization unit 30 generates an objective function represented by the sum of a plurality of functions. The optimization unit 30 then optimizes the generated objective function. For example, in the case where two prediction models have been generated, the optimization unit 30 generates a first objective function on the basis of the explained variable predicted by the first prediction model and generates a second objective function on the basis of the explained variable predicted by the second prediction model. The optimization unit 30 then optimizes the generated first and second objective functions.

The way for the optimization unit 30 to perform optimization processing is not limited. For example, in the case of a problem of maximizing expected gross sales, the optimization unit 30 generates, as an objective function, the total sum of products of the sales volumes predicted on the basis of the prediction model and the prices of the products based on the constraints as illustrated in FIG. 4. Then, the optimization unit 30 may optimize the generated objective function to identify the prices of the products that maximize the gross sales. It should be noted that the target of optimization may be gross profits instead of the gross sales.

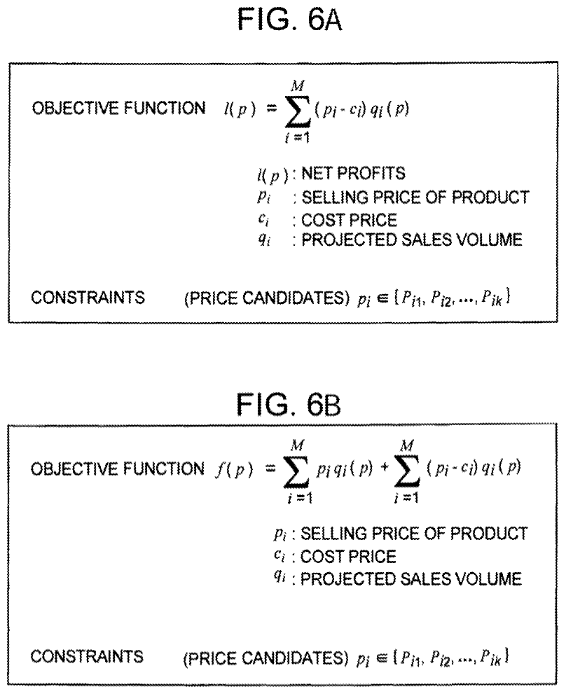

FIG. 6 is a diagram illustrating examples of optimization problems. The objective function illustrated in FIG. 6(a) is a function for calculating, as net profits, the total sum obtained by multiplying a difference between a selling price and a cost price of a product by a predicted sales volume. Specifically, the sales volume is predicted by a prediction model learned by the learning unit 20. The optimization unit 30 optimizes the objective function to maximize the gross profits on the basis of the constraints, illustrated in FIG. 6(a), representing the price candidates.

The objective function illustrated in FIG. 6(b) is a function for maximizing gross profits and gross sales. The optimization unit 30 may also optimize the objective function so as to maximize the gross profits and the gross sales on the basis of the constraints representing the price candidates illustrated in FIG. 6(b).

The evaluation unit 40 evaluates the result of the optimization by the optimization unit 30 for each objective function. Specifically, in the case where the evaluation is performed using cross validation, the evaluation unit 40 identifies the sample group that was not used for learning the prediction model in the learning of the prediction model used to generate the objective function as the target of optimization. The evaluation unit 40 then uses the identified sample group to evaluate the results of the optimization for the respective functions representing the objective function.

For example, suppose that the optimization unit 30 has generated a first objective function using the first prediction model learned using the first sample group. At this time, the evaluation unit 40 evaluates the result of the optimization using the second sample group. Similarly, suppose that the optimization unit 30 has generated a second objective function using the second prediction model learned using the second sample group. At this time, the evaluation unit 40 evaluates the result of the optimization using the first sample group. For example, in the case of a price optimization problem, the evaluation unit 40 may evaluate the result of the optimization by calculating the profits on the basis of the identified prices.

In the case where the evaluation is performed using the bootstrap method, the evaluation unit 40 estimates a bias on the basis of the optimization result for each objective function used for the optimization and corrects the optimization result on the basis of the estimated bias.

Further, the evaluation unit 40 may evaluate the result of the optimization by aggregating results of the optimization by respective objective functions. Specifically, the evaluation unit 40 may calculate, as the result of the optimization, an average of the results of the optimization by the respective objective functions. Further, in the example shown in FIG. 6(b), the evaluation unit 40 may evaluate the result of the optimization by calculating the gross profits and the gross sales on the basis of the identified prices.

In the scene of price optimization, the evaluation system of the present embodiment can be used to estimate the profits and the sales, respectively, at the time of optimization, while suppressing the optimistic bias. Further, for example in the case where it is desired to increase both of the profits and the sales as much as possible, the optimization unit 30 may solve the problem of maximizing the value of an objective function defined as “profits+sales”. The evaluation unit 40 may then perform evaluations of the profits and the sales, respectively. Further, for example in the case where profits are to be emphasized rather than sales, an objective function may be defined which places a greater weight on the function of profits (e.g., 2×profits+sales).

The output unit 50 outputs a result of optimization. The output unit 50 may output the result of optimization and an evaluation of that result. The output unit 50 may display the optimization result in a display device (not shown), or it may store the optimization result in the storage unit 10.

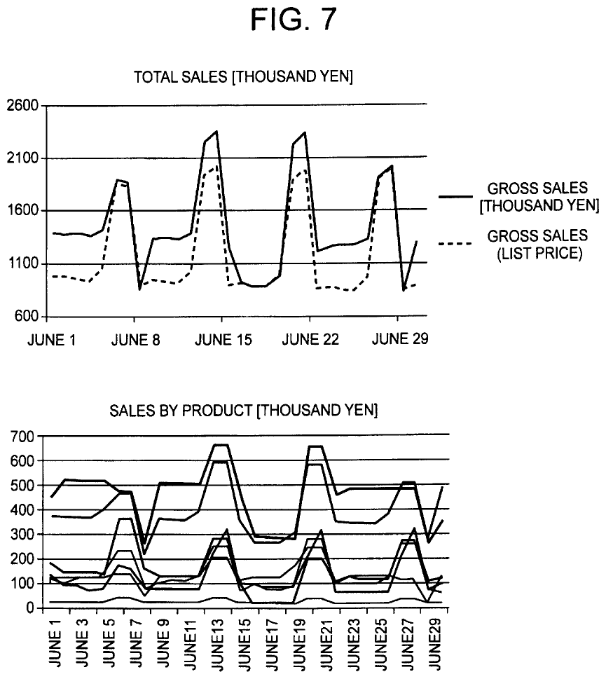

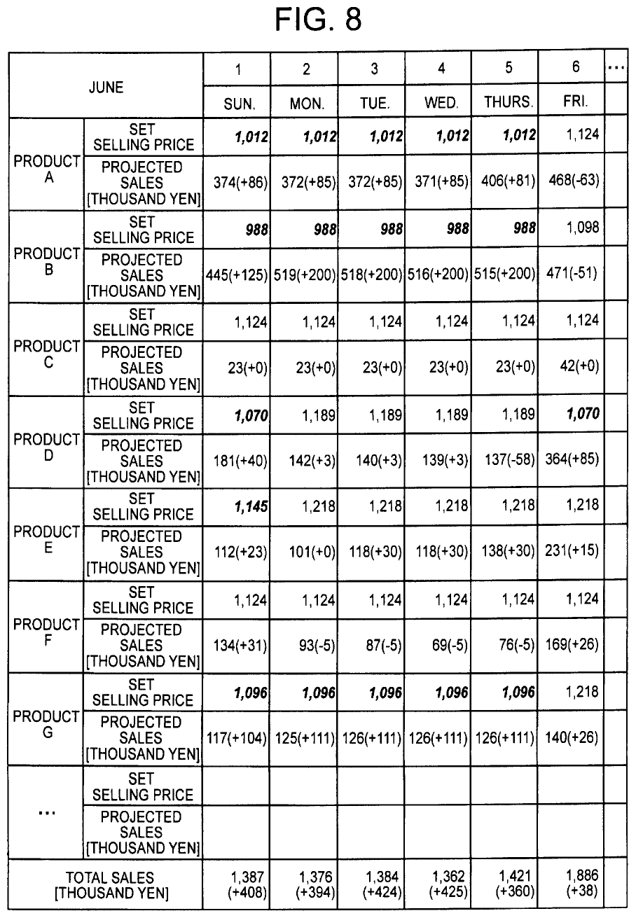

FIGS. 7 and 8 are diagrams illustrating examples of outputting evaluation results. As illustrated in FIG. 7, the output unit 50 may display the sales value by product or total sales in the form of graph on the basis of the optimization results. Further, the output unit 50 may display in a superimposed manner the optimization results by function such as profits and sales. Further, as illustrated in FIG. 8, the output unit 50 may display sales forecasts for the set selling prices in the form of table. At this time, the output unit 50 may display the list prices and the discounted selling prices in a distinguishable manner.

The learning unit 20, the optimization unit 30, the evaluation unit 40, and the output unit 50 are implemented by a processor (e.g., a central processing unit (CPU), a graphics processing unit (GPU), a field-programmable gate array (FPGA)) of a computer that operates in accordance with a program (the program for evaluation).

For example, the program may be stored in the storage unit 10, and the processor may read the program and operate as the learning unit 20, the optimization unit 30, the evaluation unit 40, and the output unit 50 in accordance with the program. Further, the functions of the evaluation system may be provided in the form of Software as a Service (SaaS).

The learning unit 20, the optimization unit 30, the evaluation unit 40, and the output unit 50 may each be implemented by dedicated hardware. Alternatively, some or all of the constituent components of the devices may be implemented by general-purpose or dedicated circuitry, processors, or any combination thereof. They may be configured by a single chip or a plurality of chips connected via a bus. Some or all of the constituent components of the devices may be implemented by a combination of the above-described circuitry or the like and the program.

Further, in the case where some or all of the components of the evaluation system are implemented by a plurality of information processing devices or circuits, the plurality of information processing devices or circuits may be arranged in a centralized or distributed manner. For example, the information processing devices or circuits may be implemented in the form of a client server system, a cloud computing system, or the like, where they are connected via a communication network.

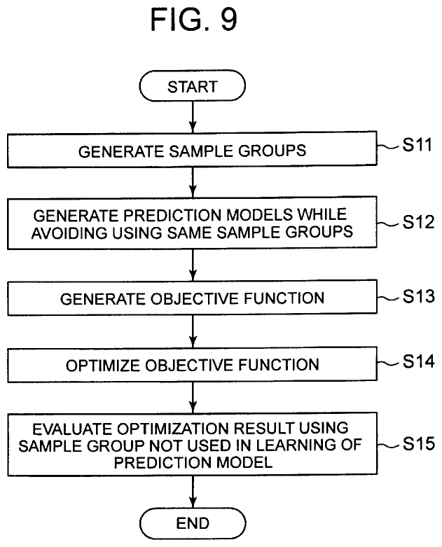

An operation of the evaluation system according to the present embodiment will now be described. FIG. 9 is a flowchart illustrating an exemplary operation of the evaluation system of the present embodiment.

The learning unit 20 generates a plurality of sample groups from samples used for learning (step S11). Then, the learning unit 20 generates a plurality of prediction models in such a manner that the sample groups among the generated sample groups used for learning of the respective models do not overlap each other (step S12). The optimization unit 30 generates an objective function on the basis of an explained variable predicted by the prediction model and constraints for optimization (step S13). Then, the optimization unit 30 optimizes the generated objective function (step S14). The evaluation unit 40 evaluates the result of optimization using the sample group that was not used in the learning of the prediction model (step S15).

As described above, in the present embodiment, the learning unit 20 generates a plurality of sample groups and generates a plurality of prediction models such that the sample groups used for learning do not overlap. Further, the optimization unit 30 generates an objective function represented by the sum of a plurality of functions, on the basis of an explained variable (prediction target) predicted by the prediction model and the constraints for optimization, and optimizes the objective function. Then, the evaluation unit 40 evaluates the result of optimization for each function, by using the sample group that was not used in the learning of the prediction model. It is thus possible to perform the evaluation while suppressing an optimistic bias in predictive optimization.

In the present embodiment, price optimization that maximizes gross sales has been described. In addition, the evaluation system of the present embodiment can be used to evaluate the result of a portfolio optimization problem to find the optimal way to invest.

The goal of the portfolio optimization problem is to minimize the risks (i.e., variation and/or variance in rate of return) as much as possible while maximizing the returns (i.e., average and/or expected rate of return) earned by the investment as much as possible. To address the problem, for example, an objective function is defined as: (magnitude of returns)−weighting factor×(magnitude of risks), and the optimization unit 30 maximizes this objective function. In the present embodiment, the magnitude of the returns and the magnitude of the risks can respectively be estimated while suppressing the optimistic bias.

That is, as explained above, a plurality of evaluation indicators may exist as in the cases of price optimization problems that increase both profits and sales, and portfolio optimization problems that consider trade-offs between the magnitude of returns and the magnitude of risks. In the case where it is necessary to consider such trade-offs and balances of the evaluation indicators, a conceivable method is to optimize the weighted sum of those evaluation indicators as an objective function.

If the results of optimization are estimated simply using an ordinary method, the optimistic bias as explained above may be included. In the present embodiment, the values of the plurality of evaluation indicators can be estimated while suppressing the optimistic bias.

A description will now be made about the reasons why a bias-free estimator is generated by the estimation system of the present embodiment. Here, the manners of generating an estimator using the cross validation method and the bootstrap method, respectively, will be described.

Firstly, a method of performing an evaluation with no bias using the cross validation method will be described. The main idea of the cross validation method is to divide data x∈X^{N} into two portions of x₁∈X^{N1} and x₂∈X^{N2} (where N₁+N₂=N). It should be noted that x₁ and x₂ are independent random variables because the elements in x₁ and x₂ follow p independently. Hereinafter, an estimator based on x₁ will be denoted as θ₁\hat{ }, and an estimator based on x₂ will be denoted as θ₂\hat{ }.

An optimal strategy based on each estimator is represented by the following expression 8.

[Math. 11]

\hat{z}ᵢ:=arg max_{z∈Z}f(z,\hat{θ}ᵢ) (Expression 8)

At this time, z₁\hat{ } and θ₂\hat{ } are independent, and z₂\hat{ } and θ₁\hat{ } are also independent. Therefore, the following expression 9 holds for the respective functions fᵢ (i=1, 2, . . . , m).

[Math. 12]

[symbol]

ₓ[fᵢ(\hat{z}₁,\hat{θ}₂)]= [symbol] ₓ_{₁}[fᵢ(\hat{z}₁,θ*)] (Expression 9)

Further, if N₁ is sufficiently large, then the following 10 becomes close to the expression 11. This idea can be extended to k-cross validation, where data x is divided into K portions.

[Math. 13]

[symbol]

ₓ_{₁}[fᵢ(\hat{z}₁,θ*)] (Expression 10)

[symbol]

ₓ[fᵢ(\hat{z}₁,θ)] (Expression 11)

zₖ^{˜} is calculated from (x₁, . . . , x_{K})\(xₖ), and θₖ\hat{ } is calculated from xₖ. At this time, for each i=1, 2, . . . , m, the value CV_{K}⁽ⁱ⁾ shown in the following expression 12 satisfies the expression 13 below. In the expression 13, z^{˜} represents the strategy calculated from (K−1)N′ samples.

$$\begin{matrix}[ Math . 14 ] & \\ {CV}_{K}^{( i )} := \frac{1}{N} {\sum }_{n = 1}^{N} {f}_{i} ( {\tilde{z}}_{k} , {\hat{θ}}_{k} ) & ( Expression 12 ) \\ {𝔼}_{x} [ {CV}_{K}^{( i )} ] = {𝔼}_{{x}^{′}} [ {f}_{i} ( \tilde{z} , {θ}^{*} ) ] & ( Expression 13 )\end{matrix}$$

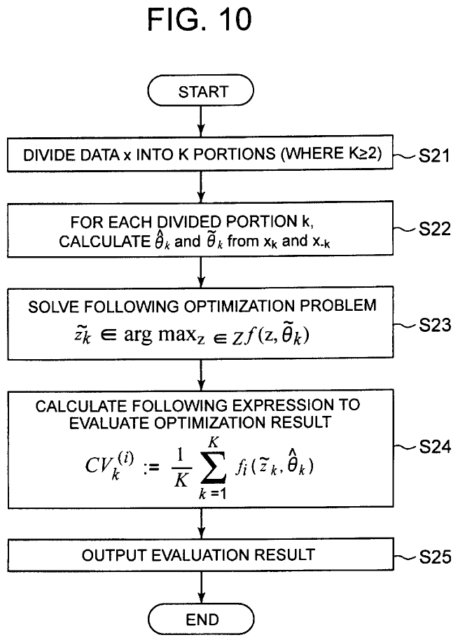

FIG. 10 is a flowchart illustrating an example of an evaluation method using the cross validation method. Specifically, FIG. 10 illustrates an example of an algorithm for generating an estimator f(z^{˜}, θ*). Firstly, the learning unit 20 divides data x∈X^{N} into K portions x₁, . . . , x_{K} (where K≥2) (step S21). Next, when x₋ₖ is defined as all samples of x excluding xₖ, the learning unit 20 calculates θₖ\hat{ } and θₖ^{˜} from xₖ and x₋ₖ for each divided portion k (step S22). The optimization unit 30 solves the optimization problem shown in the following expression 14 (step S23).

[Math. 15]

\tilde{z}ₖ∈arg max_{z∈Z}f(z,\tilde{θ}ₖ) (Expression 14)

The evaluation unit 40 evaluates the optimization results by calculating the expression 12 shown above with respect to each i=1, 2, . . . , and m (step S24), and the output unit 50 outputs the evaluation results (step S25).

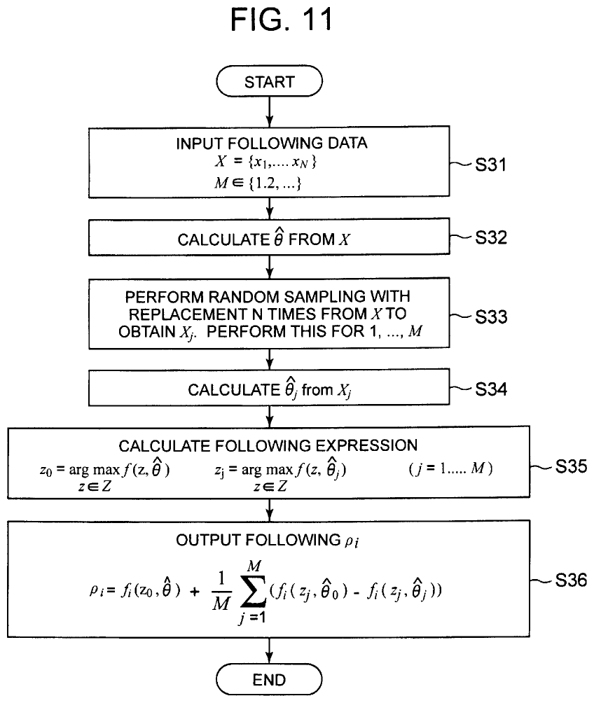

Next, a method of performing an evaluation with no bias using the bootstrap method will be described. FIG. 11 is a flowchart illustrating an example of an evaluation method using the bootstrap method. Firstly, N samples X={x₁, . . . , x_{N}} and M∈{1, 2, . . . } are input into the evaluation system 100 (step S31). Here, for j=1, . . . , M, Xⱼ based on the bootstrap method are assumed to be N random samples from X.

The learning unit 20 calculates an estimate θ\hat{ } having asymptotic normality from X (step S32). The learning unit 20 performs random sampling with replacement N times from X to obtain Xⱼ. The unit performs this for j=1, 2, . . . , M (step S33). Similarly, the learning unit 20 calculates θⱼ\hat{ } from Xⱼ (step S34). The optimization unit 30 calculates z shown in the expression 15 below (step S35). That is, the optimization unit 30 repeats M times the calculation of z.

$$\begin{matrix}[ Math . 16 ] & \\ {z}_{0} = {arg max}_{z ∈ Z} f ( z , \hat{θ} ) , & ( Expression 15 ) \\ {z}_{j} = {arg max}_{z ∈ Z} f ( z , {\hat{θ}}_{j} ) ( j = 1 , … , M ) & \end{matrix}$$

The evaluation unit 40 calculates ρᵢ, represented by the following expression 16, for each i=1, 2, . . . , m (step S36), and the output unit 50 outputs ρᵢ for each i=1, 2, . . . , m.

$$\begin{matrix}[ Math . 17 ] & \\ {ρ}_{i} = {f}_{i} ( {z}_{0} , \hat{θ} ) + \frac{1}{M} {\sum }_{j = 1}^{M} ( {f}_{i} ( {z}_{j} , {\hat{θ}}_{0} ) - {f}_{i} ( {z}_{j} , {\hat{θ}}_{j} ) ) & ( Expression 16 )\end{matrix}$$

In the above-described manner, the optimization unit 30 calculates zⱼ as shown in the above expression 15, and the evaluation unit 40 calculates a difference between f(zⱼ, θ₀\hat{ }) and f(zⱼ, θⱼ\hat{ }) (specifically, an average of the total sum of the differences) as a bias in evaluation value between the true model and the prediction model. It is thus possible to theoretically eliminate the bias that occurs between the two.

As described above, the present invention uses the cross validation or bootstrap method known in the fields of statistics and machine learning. Further, the present invention uses the so-called mathematical planning or operations research method. It can be said that the present invention has combined the techniques of different areas in the above-described manner to achieve an appropriate evaluation method.

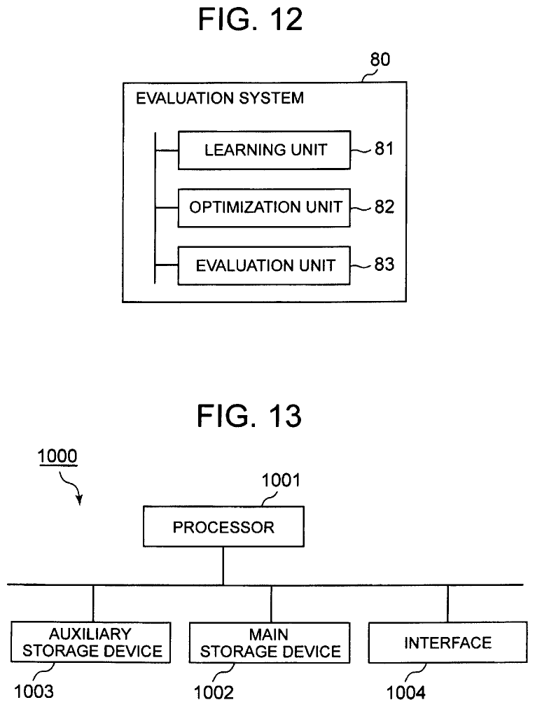

An overview of the present invention will now be described. FIG. 12 is a block diagram illustrating an overview of the evaluation system according to the present invention. The evaluation system 80 according to the present invention includes: a learning unit 81 (for example, the learning unit 20) that generates a plurality of sample groups from samples used for learning, each of the sample groups containing at least one of samples not contained in the other sample groups, and generates a plurality of prediction models using each of the generated sample groups; an optimization unit 82 (for example, the optimization unit 30) that generates objective functions, represented by the sum of a plurality of functions, on the basis of explained variables predicted by the prediction models and constraints for optimization, and optimizes the generated objective functions; and an evaluation unit 83 (for example, the evaluation unit 40) that evaluates a result of the optimization for each of the objective functions.

Such a configuration allows for an evaluation that suppresses an optimistic bias in predictive optimization.

Specifically (for example in the case where the evaluation is to be performed by cross validation), the learning unit 81 may generate a plurality of sample groups from the samples used for learning, and generate a plurality of prediction models, each of the models learned by using different set of the sample groups from other models, and the evaluation unit 83 may evaluate the result of the optimization, for each of the objective functions as the target of the optimization, by using the sample group that was not used for learning of the prediction model used for generating said objective function.

The optimization unit 82 may generate objective functions on the basis of each of the generated prediction models, and optimize the generated objective functions. The evaluation unit 83 may evaluate the result of the optimization by aggregating result of the optimization by the respective objective functions.

Specifically, the evaluation unit 83 may calculate, as the result of the optimization, an average of the results of the optimization by the respective objective functions.

Further, the learning unit 81 may generate two sample groups from the samples used for learning, and generate a first prediction model using the first sample group and a second prediction model using the second sample group. The optimization unit 82 may generate a first objective function on the basis of an explained variable predicted by the first prediction model and a second objective function on the basis of an explained variable predicted by the second prediction model, and optimize the generated first and second objective functions. Then, the evaluation unit 83 may evaluate a result of the optimization of the first objective function using the second sample group and a result of the optimization of the second objective function using the first sample group.

On the other hand (for example in the case where the evaluation is to be performed by the bootstrap method), the learning unit 81 may generate a plurality of sample groups by sampling with replacement from the samples used for learning, and generate a plurality of prediction models using each of the generated sample groups, and the evaluation unit 83 may estimate a bias on the basis of a result of the optimization for each objective function used for the optimization, and correct the result of the optimization on the basis of the estimated bias.

The learning unit 81 may generate a plurality of prediction models for predicting sales volumes of products. The optimization unit 82 may generate an objective function including a first function that calculates gross sales on the basis of selling prices of the products and the sales volumes based on the prediction models and a second function that calculates gross profits on the basis of profits obtained by subtracting cost prices from the selling prices and the sales volumes based on the prediction models, and optimize the generated objective function to identify prices of the products that maximize the gross sales and the gross profits. Then, the evaluation unit 83 may evaluate a result of the optimization by calculating the gross profits and the gross sales on the basis of the identified prices.

At this time, the optimization unit 82 may generate the objective function by using possible selling prices of the respective products as the constraints.

FIG. 13 is a schematic block diagram showing a configuration of a computer according to at least one embodiment. The computer 1000 includes a processor 1001, a main storage device 1002, an auxiliary storage device 1003, and an interface 1004.

The evaluation system described above is implemented in the computer 1000. The operations of the processing units described above are stored in the auxiliary storage device 1003 in the form of a program (the program for evaluation). The processor 1001 reads the program from the auxiliary storage device 1003 and deploys it to the main storage device 1002 to perform the above-described processing in accordance with the program.

In at least one embodiment, the auxiliary storage device 1003 is an example of a non-transitory tangible medium. Other examples of the non-transitory tangible medium include a magnetic disk, magneto-optical disk, CD-ROM, DVD-ROM, semiconductor memory, etc. connected via the interface 1004. When the program is delivered to the computer 1000 by a communication line, the computer 1000 that has received the delivery may deploy the program to the main storage device 1002 and execute the above-described processing.

The program may be for implementing a part of the functions described above. Further, the program may be a so-called differential file (differential program) which realizes the above-described functions by a combination with another program already stored in the auxiliary storage device 1003.

While the present invention has been described with reference to the embodiments and examples, the present invention is not limited to the embodiments or examples above. The configurations and details of the present invention can be subjected to various modifications appreciable by those skilled in the art within the scope of the present invention.

This application claims priority based on U.S. Provisional Application No. 62/650,389 filed on Mar. 30, 2018, the disclosure of which is incorporated herein in its entirety.

### REFERENCE SIGNS LIST

10 storage unit
20 learning unit
30 optimization unit
40 evaluation unit
50 output unit

What is claimed is:

1. An evaluation system comprising a hardware processor configured to execute a software code to:
generate a plurality of sample groups from samples used for learning, each of the sample groups containing at least one of samples not contained in the other sample groups, and generate a plurality of prediction models using each of the generated sample groups;
generate objective functions, represented by the sum of a plurality of functions, on the basis of explained variables predicted by the prediction models and constraints for optimization, and optimize the generated objective functions; and
evaluate a result of the optimization for each of the objective functions.

2. The evaluation system according to claim 1, wherein the hardware processor is configured to execute a software code to:
generate a plurality of sample groups from the samples used for learning, and generate a plurality of prediction models, each of the models learned by using different set of the sample groups from other models; and
evaluate the result of the optimization, for each of the objective functions as the target of the optimization, by using the sample group that was not used for learning of the prediction model used for generating said objective function.

3. The evaluation system according to claim 2, wherein the hardware processor is configured to execute a software code to:
generate objective functions on the basis of each of the generated prediction models, and optimize the generated objective functions; and
evaluate the result of the optimization by aggregating results of the optimization by the respective objective functions.

4. The evaluation system according to claim 3, wherein the hardware processor is configured to execute a software code to calculate, as the result of the optimization, an average of the results of the optimization by the respective objective functions.

5. The evaluation system according to claim 1, wherein the hardware processor is configured to execute a software code to:
generate two sample groups from the samples used for learning, and generate a first prediction model using the first sample group and a second prediction model using the second sample group;
generate a first objective function on the basis of an explained variable predicted by the first prediction model and a second objective function on the basis of an explained variable predicted by the second prediction model, and optimize the generated first and second objective functions; and
evaluate a result of the optimization of the first objective function using the second sample group and a result of the optimization of the second objective function using the first sample group.

6. The evaluation system according to claim 1, wherein the hardware processor is configured to execute a software code to:
generate a plurality of sample groups by sampling with replacement from the samples used for learning, and generate a plurality of prediction models using each of the generated sample groups; and
estimate a bias on the basis of a result of the optimization for each objective function used for the optimization, and correct the result of the optimization on the basis of the estimated bias.

7. The evaluation system according to claim 1, wherein the hardware processor is configured to execute a software code to:
generate a plurality of prediction models for predicting sales volumes of products;
generate an objective function including a first function that calculates gross sales on the basis of selling prices of the products and the sales volumes based on the prediction models and a second function that calculates gross profits on the basis of profits obtained by subtracting cost prices from the selling prices and the sales volumes based on the prediction models, and optimize the generated objective function to identify prices of the products that maximize the gross sales and the gross profits; and
evaluate a result of the optimization by calculating the gross profits and the gross sales on the basis of the identified prices.

8. The evaluation system according to claim 7, wherein the hardware processor is configured to execute a software code to generate the objective function by using possible selling prices of the respective products as the constraints.

9. An evaluation method comprising:
generating a plurality of sample groups from samples used for learning, each of the sample groups containing at least one of samples not contained in the other sample groups;
generating a plurality of prediction models using each of the generated sample groups;
generating objective functions, represented by the sum of a plurality of functions, on the basis of explained variables predicted by the prediction models and constraints for optimization;
optimizing the generated objective functions; and
evaluating a result of the optimization for each of the objective functions.

10. A non-transitory computer readable information recording medium storing a program for evaluation, when executed by a processor, that performs a method for:
generating a plurality of sample groups from samples used for learning, each of the sample groups containing at least one of samples not contained in the other sample groups, and generating a plurality of prediction models using each of the generated sample groups;
generating objective functions, represented by the sum of a plurality of functions, on the basis of explained variables predicted by the prediction models and constraints for optimization, and optimizing the generated objective functions; and
evaluating a result of the optimization for each of the objective functions.
